(19) United States
(12) Patent Application Publication
(10) Pub. No.: US 2021/0160253 A1
(43) Pub. Date: May 27, 2021

(54) METHODS AND SYSTEMS FOR IDENTIFYING AN IOT DEVICE

(71) Applicant: Korea Internet & Security Agency, Jeollanam-do (KR)

(72) Inventors: Jae Hyuk Lee, Jeollanam-do (KR); Woong Go, Jeollanam-do (KR); Hong Geun Kim, Jeollanam-do (KR); Mi Joo Kim, Jeollanam-do (KR); Sung Taek Oh, Jeollanam-do (KR); Soon Tai Park, Jeollanam-do (KR)

(21) Appl. No.: 16/843,834

(22) Filed: Apr. 8, 2020

(30) Foreign Application Priority Data
Nov. 25, 2019 (KR) 10-2019-0152333

(51) Int. Cl. H04L 29/06; H04L 29/08

(52) U.S. Cl. CPC H04L 63/14; G16Y 10/75; H04L 67/12

(57) ABSTRACT

Provided are methods and systems for identifying an Internet of things (IoT) device. A method of clustering an Internet of things (IoT) device, the method comprises determining a device group to which the IoT device belongs by applying the network packet of the IoT device obtained from the device identification apparatus to the clustering model, transmitting device group information according to the determination to the device identification apparatus and obtaining detailed identification information of the IoT device from the device identification apparatus, wherein the detailed identification information comprises a detailed model of the IoT device analyzed using the device group information.

### CROSS-REFERENCE TO RELATED APPLICATIONS

This application claims the benefit of Korean Patent Application No. 10-2019-0152333, filed on Nov. 25, 2019, in the Korean Intellectual Property Office, the disclosure of which is incorporated herein by reference in its entirety.

### BACKGROUND

### 1. Field

The present disclosure relates to methods and systems for identifying an Internet of things (IoT) device, and more particularly, to methods and systems for identifying an IoT device, in which a clustering server calculates group information about a product group of the IoT device on behalf of a device identification apparatus to prevent performance degradation of the device identification apparatus for identifying the IoT device.

### 2. Description of the Related Art

Internet of things (IoT) devices have vulnerabilities specific to each device model, and vulnerabilities of each device type are widely known. This may create weak network security for IoT devices that are vulnerable to attacks, which calls for a technology for detecting threats. Hence, based on the model of an IoT device being identified to effectively detect a threat to the IoT device, it is possible to efficiently prepare for the threat. However, since an IoT device is an embedded system that does not handle much information, it is not easy for a central monitoring server to identify the model of the IoT device.

A device directly connected to an IoT device in close proximity to the IoT device may identify the model of the IoT device in real time by using a network packet of the IoT device. However, to continuously identify the model of an IoT device in this way, some computational load is required on the device performing this operation. However, IoT devices are mostly connected in a home network, and most of the devices connected to the home network are configured as small computing systems (e.g., smart speakers). Based on such a small computing system continuing to analyze the models of other adjacent IoT devices in real time, it cannot properly perform its original function because its performance is degraded. Based on such a small computing system receiving some help for calculation from an external device, it can identify the model of an IoT device by itself.

However, there is currently no technology that enables a small computing system connected to a home network to identify the model of an IoT device by itself while receiving help from an external device.

### SUMMARY

Aspects of the present disclosure provide a method of clustering an Internet of things (IoT) device, the method being employed to analyze a group of an IoT device through a network packet of the IoT device.

Aspects of the present disclosure also provide a method of identifying an IoT device, in which a device identification apparatus for identifying an IoT device transmits a network packet to a clustering server, and the clustering server calculates group information about a product group of the IoT device on behalf of the device identification apparatus to prevent performance degradation of the device identification apparatus for identifying the IoT device.

However, aspects of the present disclosure are not restricted to the one set forth herein. The above and other aspects of the present disclosure will become more apparent to one of ordinary skill in the art to which the present disclosure pertains by referencing the detailed description of the present disclosure given below.

According to an aspect of the present disclosure, there is provided method of clustering an Internet of things (IoT) device being performed by a computing device and comprising generating a clustering model for identifying a group of a previously known IoT device by collecting network communication information of the IoT device, obtaining a network packet of the IoT device from a device identification apparatus connected to the IoT device through a network, determining a device group to which the IoT device belongs by applying the network packet of the IoT device obtained from the device identification apparatus to the clustering model, transmitting device group information according to the determination to the device identification apparatus and obtaining detailed identification information of the IoT device from the device identification apparatus, wherein the detailed identification information comprises a detailed model of the IoT device analyzed using the device group information.

### BRIEF DESCRIPTION OF THE DRAWINGS

These and/or other aspects will become apparent and more readily appreciated from the following description of the embodiments, taken in conjunction with the accompanying drawings in which:

FIG. 1 is an overview diagram of a system for identifying an Internet of things (IoT) device according to an embodiment of the present disclosure;

FIG. 2 is a flowchart of the system for identifying an IoT device according to the embodiment of the present disclosure;

FIG. 3 is a flowchart of a method of clustering an IoT device according to an embodiment of the present disclosure;

FIG. 4 illustrates some operations of FIG. 3 in detail;

FIG. 5 illustrates an operation in which a clustering server receives a network packet from a device identification apparatus and transmits device group information;

FIG. 6 illustrates an operation of generating a clustering model in detail;

FIG. 7 illustrates operations S103 and S104 of FIG. 6 in detail;

FIG. 8 is a flowchart of a system for identifying an IoT device according to an embodiment of the present disclosure;

FIG. 9 is a flowchart of a method of identifying an IoT device according to an embodiment of the present disclosure;

FIG. 10 illustrates operation S340 of FIG. 9 in detail; and

FIG. 11 illustrates the hardware configuration of an apparatus for clustering an IoT device according to an embodiment of the present disclosure.

### DETAILED DESCRIPTION

Hereinafter, embodiments of the present disclosure will be described with reference to the attached drawings. Advantages and features of the present disclosure and methods of accomplishing the same may be understood more readily by reference to the following detailed description of embodiments and the accompanying drawings. The present disclosure may, however, be embodied in many different forms and should not be construed as being limited to the embodiments set forth herein. Rather, these embodiments may be provided so that this disclosure will be thorough and complete and will fully convey the concept of the disclosure to those skilled in the art, and the present disclosure will be defined by the appended claims.

In adding reference numerals to the components of each drawing, it should be noted that the same reference numerals may be assigned to the same components as much as possible even though they may be shown in different drawings. In addition, in describing the present inventive concept, to the extent the detailed description of the related well-known configuration or function may obscure the gist of the present inventive concept, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein may be for the purpose of describing embodiments and may not be intended to be limiting of the inventive concept. In this specification, the singular also includes the plural unless specifically stated otherwise in the phrase.

In addition, in describing the component of this inventive concept, terms, such as first, second, A, B, (a), (b), can be used. These terms may distinguish the components from other components, and the nature or order of the components may not be limited by the terms. Based on describing a component as being “connected,” “coupled” or “contacted” to another component, that component may be directly connected to or contacted with that other component, but it should be understood that another component also may be “connected,” “coupled” or “contacted” between each component.

Hereinafter, some embodiments of the present inventive concept will be described in detail with reference to the accompanying drawings.

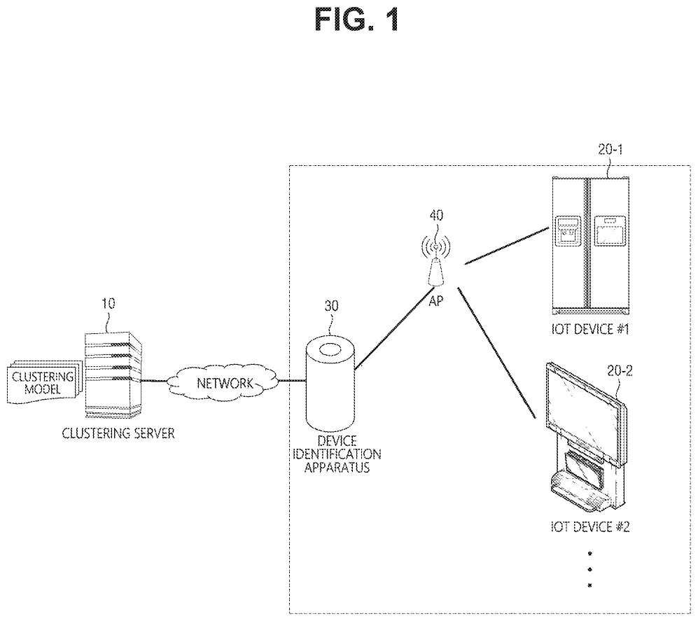

FIG. 1 is an overview diagram of a system for identifying an Internet of things (IoT) device according to an embodiment of the present disclosure.

Referring to FIG. 1, the system for identifying an IoT device according to the embodiment of the present disclosure may include a clustering server 10, IoT devices 20, a device identification apparatus 30, and an access point (AP) 40.

Each of the IoT devices 20 refers to an object with a sensor that sends and receives data over a network in real time. The IoT devices 20 may be, but may not be limited to, various embedded systems including home appliances such as refrigerators and televisions (TVs), mobile devices, and wearable devices.

The clustering server 10 may analyze to which product group an IoT device 20 belongs by using a network packet of the IoT device 20 and determine a device group of the IoT device 20. Here, the clustering server 10 may generate a clustering model by using the network packet and determine the device group by using the generated clustering model.

The device identification apparatus 30 may be connected to the IoT devices 20 and the AP 40 through the network to identify a detailed model of each IoT device 20. The device identification apparatus 30 may be formed as various electronic devices such as a home appliance, a small electronic device, and a microcontroller unit (MCU). However, the device identification apparatus 30 may not be limited to the above examples and may be any device connected to the IoT devices 20 through the AP 40 and capable of identifying the IoT devices 20. According to an embodiment, the device identification apparatus 30 may be configured in the form of an IoT device 20.

The device identification apparatus 30 may receive a network packet of an IoT device 20 from the AP 40 and transmit the received network packet to the clustering server 10. The device identification apparatus 30 may receive device group information of the IoT device 20 from the clustering server 10 and analyze detailed identification information of the IoT device 20 according to the device group information.

The AP 40 may be connected to the IoT devices 20 and the device identification apparatus 30 through the network to transmit and receive network packets. Since the AP 40 may be a widely known technology, a description thereof will be omitted.

In the system for identifying an IoT device according to the embodiment of the present disclosure, since the clustering device 10 calculates group information about a product group of an IoT device 20 on behalf of the device identification apparatus 30, it may be possible to prevent performance degradation of the device identification apparatus 30 for identifying the IoT device 20.

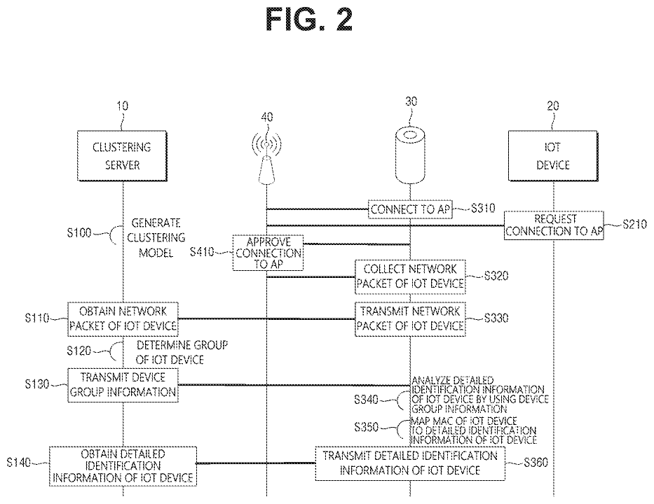

FIG. 2 is a flowchart of the system for identifying an IoT device according to the embodiment of the present disclosure.

Referring to FIG. 2, a clustering model may be generated by the clustering server 10 in operation S100. The clustering model may be a model that can analyze to which product group an IoT device 20 belongs through a network packet. For example, the clustering model may analyze whether the IoT device 20 belongs to a TV product group, a refrigerator product group, or a sensor product group based on a network packet of the IoT device 20 and determine a device group to which the IoT device 20 belongs. The device group may be a set of product groups.

In operations S210 and S310, the IoT device 20 and the device identification apparatus 30 may request a connection to the AP 40 and connect to the AP 40 via network according to a connection approval of the AP 40. The order of the connecting operation and the connection approval of the AP 40 can be variously changed and may not be limited to the order in FIG. 2. In operation S320, a network packet of the IoT device 20 may be collected by the device identification apparatus 30. Here, the network packet of the IoT device 20 may be collected by the device identification apparatus 30 through the AP 40 at preset time intervals. A group of the IoT device 20 continuously located nearby may be automatically determined. For example, in response to suddenly locating a new IoT device 20 nearby, a group of the new IoT device 20 may be immediately and automatically determined.

In operation S330, the collected network packet may be transmitted to the clustering server 10. The network packet may be obtained by the clustering server 10 in operation S110.

In operation S120, the group of the IoT device 20 may be determined by the clustering server 10. In operation S130, device group information according to the determination may be transmitted to the device identification apparatus 30. In operation S340, detailed identification information of the IoT device 20 may be analyzed using the device group information.

In operation S340, the network packet of the IoT device 20 may be matched with model information corresponding to the device group information, and the detailed identification information of the IoT device 20 may be determined according to the matching result. In an embodiment, based on the matching of the network packet of the IoT device 20 and the model information corresponding to the device group information failing, the device group information may be requested again. In an embodiment, a media access control (MAC) address of the IoT device 20 may be mapped to the detailed identification information of the IoT device 20 in operation S350. The detailed identification information of the IoT device 20 may be transmitted in operation S360 and obtained by the clustering server 10 in operation S140.

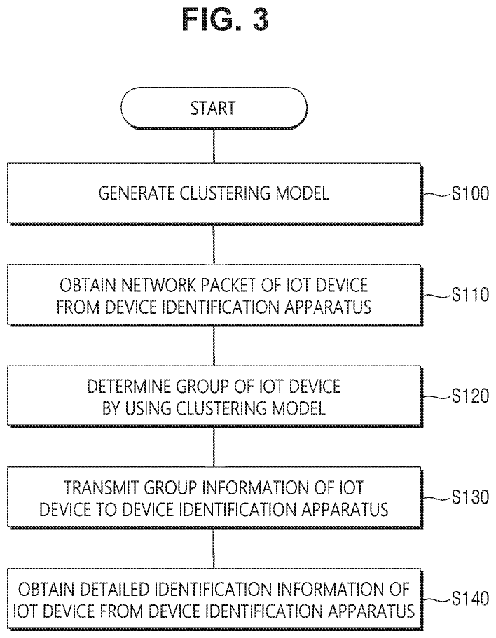

Operations S100 through S140 may be operations performed by the clustering server 10 and will be described in more detail with reference to FIGS. 3 through 8.

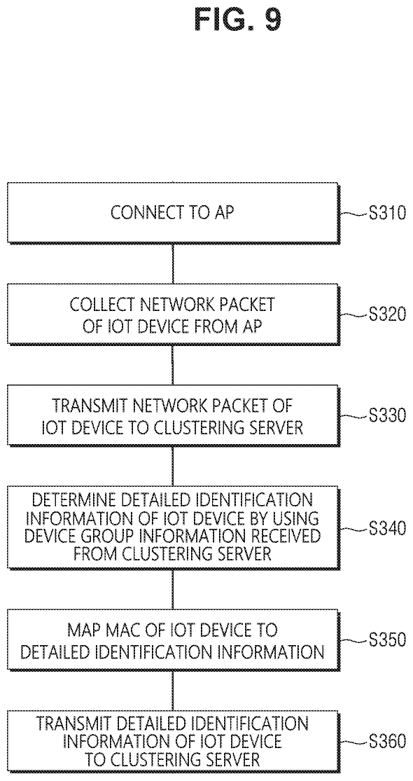

Operations S310 through S360 may be operations performed by the device identification apparatus 30 and will be described in detail with reference to FIG. 9 and subsequent drawings.

FIG. 3 is a flowchart of a method of clustering an IoT device according to an embodiment of the present disclosure.

Referring to FIG. 3, in operation S100, a clustering model may be generated by the clustering server 10. The clustering server 10 may generate a clustering model for identifying a group of a previously known IoT device 20 by collecting network communication information of the IoT device 20.

In operation S120, a group of an IoT device 20 may be determined using the clustering model. Here, the clustering server 10 may determine the group of the IoT device 20 by applying a network packet of the IoT device 20 to the clustering model to analyze whether the IoT device 20 belongs to a TV product group, a refrigerator product group, or a sensor product group.

In operation S130, device group information may be transmitted to the device identification apparatus 30, and the transmitted device group information may be used by the device identification apparatus 30 to analyze detailed identification information. Then, in operation S140, the analyzed detailed identification information of the IoT device 20 may be obtained from the device identification apparatus 30. The detailed identification information may include information about a detailed model, as compared with the product group.

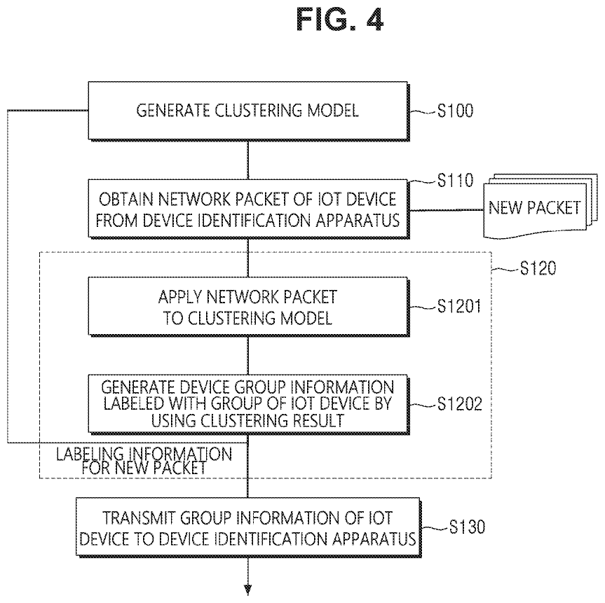

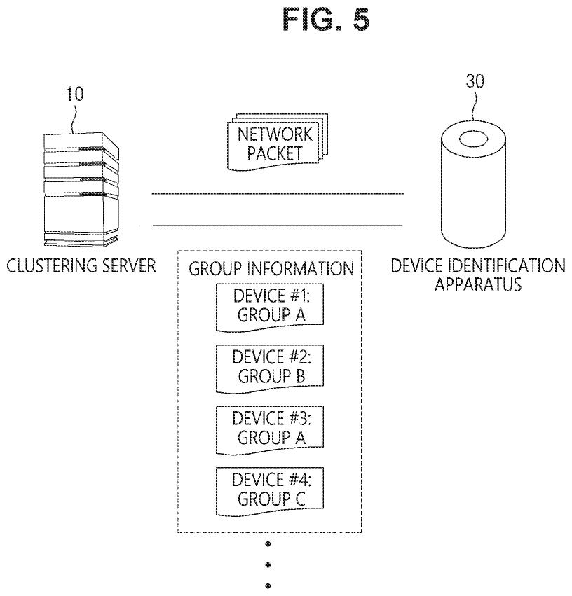

FIG. 4 illustrates some operations of FIG. 3 in detail. FIG. 5 illustrates an operation in which the clustering server 10 receives a network packet from the device identification apparatus 30 and transmits device group information.

Referring to FIG. 4, a new packet may be obtained in operation S110 of FIG. 3. In operation S110, a new network packet not received before and different from a network packet (different from a network packet received before) may be received from the device identification apparatus 30.

The network packet may be applied to the clustering model in operation S1201, and device group information labeled with a group of an IoT device 20 may be generated using the clustering result in operation S1202. For example, IoT device #1 20-1 illustrated as a refrigerator in FIG. 1 may transmit a network packet to the device identification apparatus 30 through the AP 40, and the clustering server 10 may receive the network packet of IoT device #1 20-1 formed as a refrigerator from the device identification apparatus 30. The clustering server 10 may analyze that IoT device #1 20-1 belongs to the refrigerator product group by applying the network packet to the clustering model and may generate device group information.

As the device group information may be generated, labeling information for the new packet may also be generated, and the labeling information for the new packet may be stored in a database. The labeling information for the new packet may include information about which device group information may be generated by the new type of network packet. The labeling information for the new packet may be reflected in the generating of the clustering model generated previously and used to update the clustering model.

Referring to FIG. 5, the clustering server 10 may receive a network packet from the device identification apparatus 30 and generate device group information corresponding to the received network packet. As illustrated in FIG. 5, the clustering server 10 may generate the device group information using the network packet such that device #1 may be determined as group A, device #2 as group B, and device #3 as group A, and device #4 as group C. The clustering server 10 may transmit the generated device group information to the device identification apparatus 30.

In the method of clustering an IoT device according to the embodiment of the present disclosure, since the clustering device 10 calculates group information about a product group of an IoT device 20 on behalf of the device identification apparatus 30, the amount of information processed by the device identification apparatus 30 for identifying the IoT device 20 can be reduced, thereby preventing performance degradation of the device identification apparatus 30.

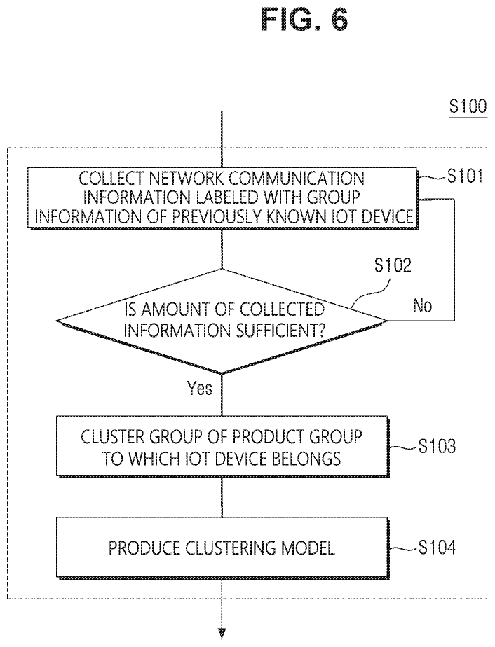

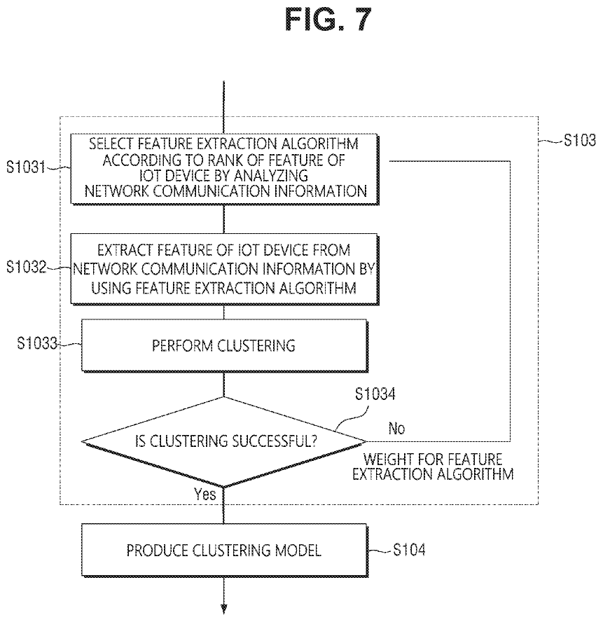

FIG. 6 illustrates an operation of generating a clustering model in detail. FIG. 7 illustrates operations S103 and S104 of FIG. 6 in detail.

Referring to FIG. 6, network communication information labeled with group information of a previously known IoT device 20 may be collected in operation S101. The network communication information may be information obtained through a cloud server directly or indirectly connected to the clustering server 10. The network communication information may be previously known information and may be data that records which labeling may be included in a network packet of the known IoT device 20. The network communication information may be used by the clustering server 10 to generate a clustering model.

Based on determining in operation S102 that the network communication information may be sufficient, clustering may be performed to determine which network packet may be classified as which IoT device 20 in operation S103. This process may be learned to produce a clustering model in operation S104. Based on the amount of network communication information of the previously known IoT device 20 (e.g., less than a preset size, input size, or size learned from machine learning, however the amount may not be limited to the above examples), the network communication information of the known IoT device 20 may be additionally collected.

Referring to FIG. 7, the process of producing a clustering model may be divided into more specific operations. In operation S1031, an appropriate feature extraction algorithm may be selected according to a rank of a feature of the IoT device 20 by analyzing the network communication information. In operation S1032, the feature of the IoT device 20 may be extracted from the network communication information by using the selected feature extraction algorithm.

Then, in operation S1033, clustering may be performed using the extracted feature. In an embodiment, the clustering may be K-means clustering (K=the number of product groups of previously known IoT devices 20).

In operation S1034, the result of the clustering may be analyzed based on a labeling included in the network communication information. Based on the accuracy of the clustering result (e.g., equal to or greater than a preset accuracy level), it may be determined that the generation of the clustering model may be successful. In an embodiment, based on the accuracy of the clustering result being preset accuracy (e.g., 100%, 90%, 80%, or, a preset percentage, input accuracy, or accuracy learned from machine learning, however the accuracy may not be limited to the above examples) it may be determined that the generation of the clustering model may be successful.

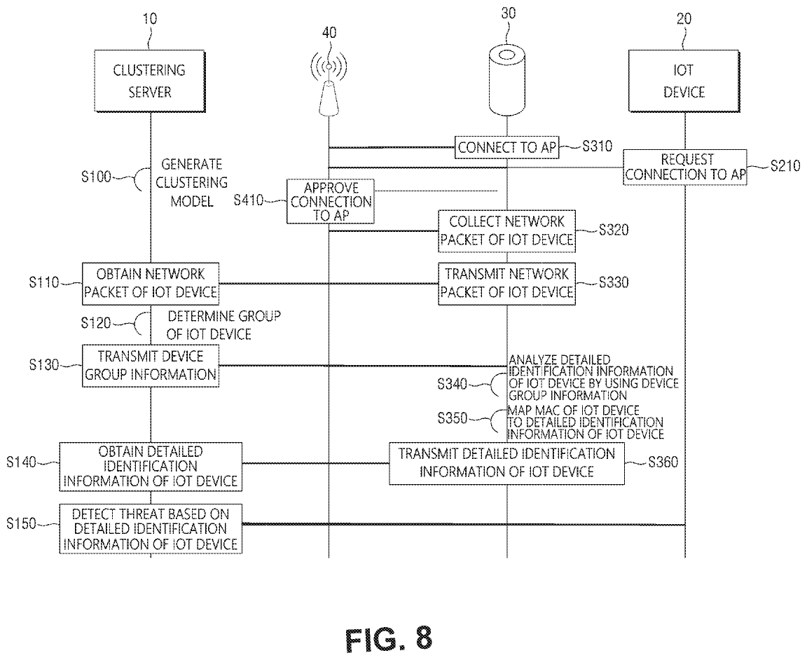

FIG. 8 is a flowchart of a system for identifying an IoT device according to an embodiment of the present disclosure.

The system for identifying an IoT device according to the embodiment of the present disclosure operates in the same way as described above except for operation S150, and a description of the same operations will be omitted. In operation S150, a clustering server 10 may detect a security threat to an IoT device 20 based on detailed identification information of the IoT device 20.

In the current embodiment, operations S140 and S150 may be shown to be performed by the clustering server 10. However, operations S140 and S150 may also be performed by another apparatus. For example, detailed identification information of the IoT device 20 may be obtained by the clustering server 10, and a threat to the IoT device 20 may be detected by a second apparatus. Alternatively, the detailed identification information of the IoT device 20 may be obtained by the second apparatus, and a threat to the IoT device 20 may be detected by the second apparatus. Alternatively, the detailed identification information of the IoT device 20 may be obtained by the second apparatus, and a threat to the IoT device 20 may be detected by a third apparatus. The present disclosure may not be limited to the above embodiments, and each operation may also be performed by various apparatuses.

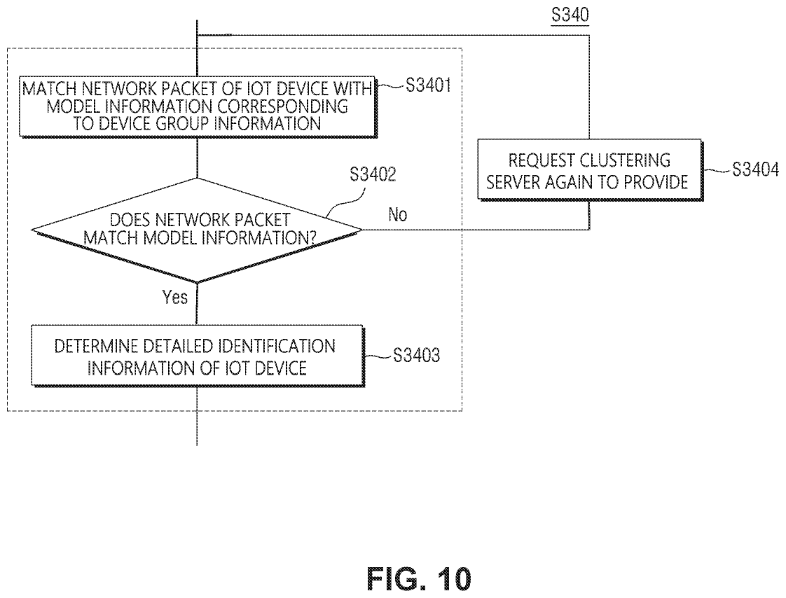

FIG. 9 is a flowchart of a method of identifying an IoT device according to an embodiment of the present disclosure. FIG. 10 illustrates operation S340 of FIG. 9 in detail.

Referring to FIG. 9, in the method of identifying an IoT device according to the embodiment of the present disclosure, after connection to an AP 40 in operation S310, a network packet received from an IoT device 20 in operation S320 may be transmitted to a clustering server 10 in operation S330. Here, the network packet may be collected at preset time intervals (e.g., input time intervals, or time intervals learned from machine learning, however the amount may not be limited to the above examples). In the method of identifying an IoT device according to the embodiment of the present disclosure, since the network packet may be collected and transmitted at the preset time intervals, a group of the IoT device 20 continuously located nearby may be automatically determined. For example, in response to suddenly location a new IoT device 20 nearby, a group of the new IoT device 20 may be immediately and automatically determined. Here, device group information may include information that may be applied to a clustering model performed by the clustering server 10 to determine the group of the IoT device 20.

In operation S340, detailed identification information of the IoT device 20 may be determined using the device group information received from the clustering server 10. Referring to FIG. 10, the network packet of the IoT device 20 may be matched with model information corresponding to the device group information in operation S3401. Based on determining in operation S3402 that the network packet matches the model information, the detailed identification information of the IoT device 20 may be determined according to the matching result in operation S3403.

In an embodiment, feature information for identifying each model existing in a product group of the device group information may be matched and checked one-to-one with the network packet. For example, based on determining that the IoT device 20 may be an artificial intelligence (AI) speaker through the device group information and based on the model of the AI speaker being Amazon Echo, the detailed identification information may be determined to be Amazon Echo based on a determination through the network packet that web server connection using a 54442 port may be possible because Amazon Echo can access a web server using the 54442 port. The detailed identification information may also be determined in the same way based on a determination that the IoT device 20 may be a smart outlet, a smart bulb, or the like through the device group information.

Based on determining in operation S3402 that the network packet does not match the model information, that is, based on the matching of the network packet of the IoT device 20 and the model information corresponding to the device group information failing, the clustering server 10 may be requested again to provide the device group information in operation S3404. Based on a receipt of the device group information from the clustering server 10 according to the re-request, operations S3401 and S3402 may be performed again using the received device group information.

In an embodiment, a MAC address of the IoT device 20 may be mapped to the detailed identification information in operation S350. The analyzed detailed identification information may be transmitted to the clustering server 10 in operation S360.

The methods according to the embodiments of the present disclosure described so far can be performed by the execution of a computer program implemented as computer-readable code. The computer program may be transmitted from a first computing device to a second computing device through a network such as the Internet and may be installed in the second computing device and used in the second computing device, Examples of the first computing device and the second computing device include fixed computing devices such as a server device, a physical server belonging to a server pool for a cloud game service, and a desktop PC.

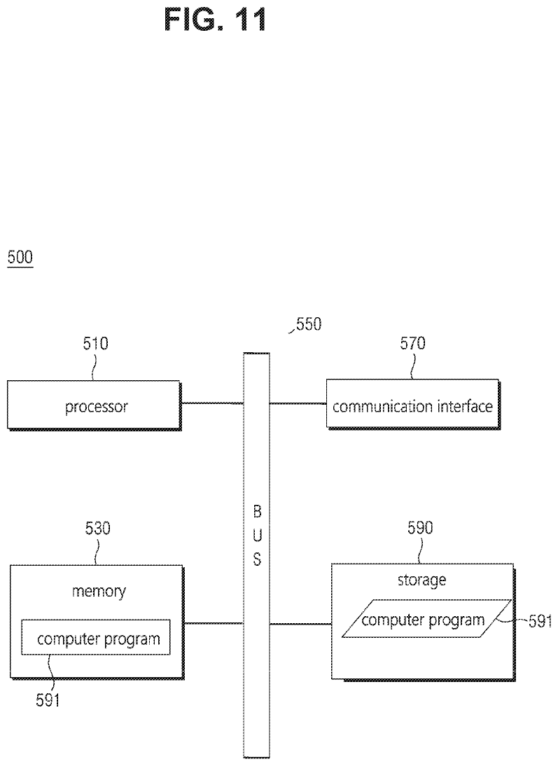

The computer program may be stored in a recording medium such as a DVD-ROM or a flash memory. The hardware configuration of a server 100 for clustering an IoT device according to an embodiment of the present disclosure will now be described with reference to FIG. 11.

FIG. 11 is an example hardware diagram illustrating a computing device 500.

As shown in FIG. 11, the computing device 500 may include one or more processors 510, a bus 550, a communication interface 570, a memory 530, which loads a computer program 591 executed by the processors 510, and a storage 590 for storing the computer program 591. However, FIG. 11 illustrates the components related to the embodiment of the present disclosure. It will be appreciated by those skilled in the art that the present disclosure may further include other general purpose components in addition to the components shown in FIG. 11.

The processor 510 controls overall operations of each component of the computing device 500. The processor 510 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 510 may perform calculations on at least one application or program for executing a method/operation according to various embodiments of the present disclosure. The computing device 500 may have one or more processors.

The memory 530 stores various data, instructions and/or information. The memory 530 may load one or more programs 591 from the storage 590 to execute methods/operations according to various embodiments of the present disclosure. For example, based on loading the computer program 591 into the memory 530, the logic (or the module) as shown in FIG. 11 may be implemented on the memory 530. An example of the memory 530 may be a RAM, but is not limited thereto.

The bus 550 provides communication between components of the computing device 500. The bus 550 may be implemented as various types of bus such as an address bus, a data bus and a control bus.

The communication interface 570 supports wired and wireless internet communication of the computing device 500. The communication interface 570 may support various communication methods other than internet communication. To this end, the communication interface 570 may be configured to comprise a communication module well known in the art of the present disclosure.

The storage 590 can non-temporarily store one or more computer programs 591. The storage 590 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 591 may include one or more instructions, on which the methods/operations according to various embodiments of the present disclosure may be implemented. Based on loading the computer program 591 on the memory 530, the processor 510 may perform the methods/operations in accordance with various embodiments of the present disclosure by executing the one or more instructions.

In an embodiment, a clustering model generation program 591 may include an instruction for generating a clustering model for identifying a group of a previously known IoT device 20 by collecting network communication information of the IoT device 20, an instruction for obtaining a network packet of the IoT device 20 from a device identification apparatus 30 connected to the IoT device 20 through a network, an instruction for determining a device group to which the IoT device 20 belongs by applying the network packet of the IoT device 20 obtained from the device identification apparatus 30 to the clustering model, an instruction for transmitting device group information according to the determination to the device identification apparatus 30, and an instruction for obtaining detailed identification information of the IoT device 20 from the device identification apparatus 30. The detailed identification information may include a detailed model of the IoT device 20 analyzed using the device group information.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although the operations may be shown in an order in the drawings, those skilled in the art will appreciate that many variations and modifications can be made to the embodiments without substantially departing from the principles of the present inventive concept. The disclosed embodiments of the inventive concept may be used in a generic and descriptive sense and not for purposes of limitation. The scope of protection of the present inventive concept should be interpreted by the following claims, and all technical ideas within the scope equivalent thereto should be construed as being included in the scope of the technical idea defined by the present disclosure.

What is claimed is:

1. A method of clustering an Internet of things (IoT) device, the method being performed by a computing device and comprising:
generating a clustering model for identifying a group of a previously known IoT device by collecting network communication information of the IoT device;
obtaining a network packet of the IoT device from a device identification apparatus connected to the IoT device through a network;
determining a device group to which the IoT device belongs by applying the network packet of the IoT device obtained from the device identification apparatus to the clustering model;
transmitting device group information according to the determination to the device identification apparatus; and
obtaining detailed identification information of the IoT device from the device identification apparatus,
wherein the detailed identification information comprises a detailed model of the IoT device analyzed using the device group information.

2. The method of claim 1, wherein the generating of the clustering model comprises:
collecting network communication information labeled with group information of a previously known IoT device;
clustering a group of a product group to which the IoT device belongs by using the labeled network communication information; and
producing a clustering model of the IoT device according to the clustering.

3. The method of claim 2, wherein the clustering of the group of the product group to which the IoT device belongs comprises:
selecting a feature extraction algorithm according to a rank of a feature of the IoT device by analyzing the network communication information; and
extracting the feature from the network communication information by using the selected feature extraction algorithm.

4. The method of claim 3, wherein the clustering of the group of the product group to which the IoT device belongs further comprises analyzing the clustering result based on a labelling included in the network communication information and determining that the generating of the clustering model is successful based on the accuracy of the clustering result being equal to or greater than a preset accuracy level.

5. The method of claim 3, wherein the clustering of the group of the product group to which the IoT device belongs further comprises updating the feature extraction algorithm by reflecting an error of a weight for the feature extraction algorithm based on the generating of the clustering model failing.

6. The method of claim 1, wherein the generating of the clustering model comprises:
generating the clustering model based on the amount of network communication information of the previously known IoT device being equal to or greater than a preset size; and
additionally collecting the network communication information of the previously known IoT device based on the amount of network communication information of the previously known IoT device being less than the preset size.

7. The method of claim 1, wherein the obtaining of the network packet of the IoT device comprises obtaining a network packet obtained by the device identification apparatus connected to the IoT device through an access point (AP).

8. The method of claim 7, wherein the obtaining of the network packet obtained by the device identification apparatus connected to the IoT device through the AP comprises obtaining from the device identification apparatus a network packet collected by the device identification apparatus through the AP at preset time intervals.

9. The method of claim 1, wherein the determining of the device group to which the IoT device belongs comprises generating device group information labeled with a group to which the IoT device belongs.

10. The method of claim 9, wherein the generating of the device group information comprises updating the clustering model by reflecting the labeled information in the clustering model.

11. The method of claim 1, wherein the obtaining of the detailed identification information comprises matching the network packet of the IoT device with model information corresponding to the device group information and determining detailed identification information of the IoT device according to the matching result.

12. The method of claim 11, wherein the determining of the detailed identification information of the IoT device according to the matching result comprises mapping a media access control (MAC) address of the IoT device to the detailed identification information.

13. The method of claim 11, wherein the obtaining of the detailed identification information further comprises receiving a re-request for the device group information based on a failure of matching of the network packet of the IoT device and the model information corresponding to the device group information.

14. The method of claim 1, further comprising detecting a security threat to the IoT device based on the detailed identification information.

15. A server for clustering an IoT device, the server comprising:
a processor;
a network interface;
a memory which is executed by the processor to load a computer program,
wherein the computer program comprises:
an instruction for generating a clustering model for identifying a group of a previously known IoT device by collecting network communication information of the IoT device;
an instruction for obtaining a network packet of the IoT device from a device identification apparatus connected to the IoT device through a network;
an instruction for determining a device group to which the IoT device belongs by applying the network packet of the IoT device obtained from the device identification apparatus to the clustering model;
an instruction for transmitting device group information according to the determination to the device identification apparatus; and
an instruction for obtaining detailed identification information of the IoT device from the device identification apparatus,
wherein the detailed identification information comprises a detailed model of the IoT device analyzed using the device group information.

16. A computer program coupled to a computing device and stored in a computer-readable recording medium to execute:
an operation of generating a clustering model for identifying a group of a previously known IoT device by collecting network communication information of the IoT device;
an operation of obtaining a network packet of the IoT device from a device identification apparatus connected to the IoT device through a network;
an operation of determining a device group to which the IoT device belongs by applying the network packet of the IoT device obtained from the device identification apparatus to the clustering model;
an operation of transmitting device group information according to the determination to the device identification apparatus; and
an operation of obtaining detailed identification information of the IoT device from the device identification apparatus,
wherein the detailed identification information comprises a detailed model of the IoT device analyzed using the device group information.

17. The computer program of claim 16, wherein the generating of the clustering model comprises:
collecting network communication information labeled with group information of a previously known IoT device;
clustering a group of a product group to which the IoT device belongs by using the labeled network communication information; and
producing a clustering model of the IoT device according to the clustering.

18. The computer program of claim 16, wherein the generating of the clustering model comprises:
generating the clustering model based on the amount of network communication information of the previously known IoT device being equal to or greater than a preset size; and
additionally collecting the network communication information of the previously known IoT device based on the amount of network communication information of the previously known IoT device being less than the preset size.

19. The computer program of claim 16, wherein the obtaining of the network packet of the IoT device comprises obtaining a network packet obtained by the device identification apparatus connected to the IoT device through an access point (AP).

20. The computer program of claim 16, wherein the determining of the device group to which the IoT device belongs comprises generating device group information labeled with a group to which the IoT device belongs.
